(19) United States
(12) Patent Application Publication
(10) Pub. No.: US 2026/0084649 A1
(43) Pub. Date: Mar. 26, 2026

(54) Technology for Controlling an Access to a Motor Vehicle

(71) Applicant: Bayerische Motoren Werke Aktiengesellschaft, Muenchen (DE)

(72) Inventor: Matthias FINK, Muenchen (DE)

(21) Appl. No.: 19/333,731

(22) Filed: Sep. 19, 2025

(30) Foreign Application Priority Data
Sep. 20, 2024 (DE) 10 2024 127 160.4

(51) Int. Cl. B60R 25/04; B60R 25/24; G06F 21/33; H04L 9/40

(52) U.S. Cl. CPC B60R 25/04; B60R 25/24; G06F 21/33; H04L 63/0442; H04L 63/0823; H04L 63/10

(57) ABSTRACT

A method for controlling an access to a motor vehicle, comprising receiving a first user input; sending a first digital certificate containing an account ID of a device-side user account for at least one mobile device; receiving a second user input to initiate a sharing procedure of a shared vehicle key for the motor vehicle, wherein the shared vehicle key is derived from a digital vehicle key for the motor vehicle; sending a prompt message relating to the sharing procedure, wherein the prompt message is signed based on the first certificate; and initiating starting of a drive motor of the motor vehicle based on the shared vehicle key.

### CROSS REFERENCE TO RELATED APPLICATION

This application claims priority under 35 U.S.C. § 119 from German Patent Application No. DE 10 2024 127 160.4, filed Sep. 20, 2024, the entire disclosure of which is herein expressly incorporated by reference.

### BACKGROUND AND SUMMARY

The invention relates to a technology for controlling an access to a motor vehicle. The technology comprises, inter alia, initiating a sharing procedure of a shared vehicle key for the motor vehicle, wherein the shared vehicle key is derived from a digital vehicle key for the motor vehicle.

A motor vehicle can be secured by means of a concept which was presented as the “Digital Car Key” (DCK) by the “Car Connectivity Consortium” (CCC). A comprehensive technical description is found, for example, in the technical specification “Digital Key Release 3”. The concept provides for controlling a security function of the motor vehicle, such as a central locking function and/or an immobilizer, on the basis of an asymmetrical cryptographic method. A digital vehicle key in the form of a cryptographic data structure can be assigned to a user. A wireless connection between a mobile device and the motor vehicle is used for authentication on the basis of this key.

A digital vehicle key can comprise, for example, a private part and a public part. The private part can be stored in a secured environment of a mobile device. Vice versa, a digital key is assigned to the motor vehicle, the private part of which can be stored in a control unit on board. A public part is known on the part of a user. To control a security or access function, a two-sided authentication takes place on the basis of the respective private and public key components. If the authentication runs successfully, a requested security function on the motor vehicle is controlled, an access to or a use of the vehicle is enabled, etc.

A vehicle owner (“owner” according to the CCC; this can also be a service provider such as an automobile rental agency, etc.) has the possibility of sharing his or her key; the shared or derived key enables a user (“friend”, for example a customer of the service provider) to use the motor vehicle. Release 4 of the CCC specification provides that key sharing can also take place in a cascaded manner, i.e. a shared key can be further shared once again.

A method for sharing the key can comprise, for example, according to the CCC, that a URL (“Uniform Resource Locator”) is sent to the user. Calling the URL on a mobile device of the user then has the result that the derived or shared vehicle key is stored on this device.

Key sharing among natural persons is normally based on personal trust, for example among family members or the employees of a small company. In a general service relationship, in which the sharing of a key is to a person such as a (new) customer, an employee of a company who requires access to the vehicle of a customer for the purposes of a service, etc., no personal trust exists. In such an impersonal or anonymous environment, key sharing is an administrative procedure, and technical measures are to be provided in this case in order to establish trust in key sharing.

Carrying out key sharing using a sharing URL which the owner or administrative operator of the vehicle sends to the user, customer, employee, etc. is known. The key sharing procedure is initiated by calling the URL on the mobile device of the user, customer, employee, etc. The URL can in principle not only be called on the mobile device intended for this purpose, but rather on any arbitrary device, however. For example, the intended recipient of the shared key can (in principle) forward the URL to any other device, an unauthorized user, etc., and/or the URL can be intercepted by a malicious party and called in an abusive manner.

Additionally providing a two-factor authentication or the like is also known, for example, but this does not provide a remedy: a PIN or the like can also be forwarded as desired. There is therefore a need to prevent possible misuse by means of technical measures.

One object underlying the present invention is to provide an improved concept for a technology for controlling an access to a motor vehicle. The invention achieves this object by means of the subjects of the independent claims. Dependent claims reflect preferred embodiments.

A first aspect of the present invention relates to a method for controlling an access to a motor vehicle. The method can be implemented on the user side or device side, for example on a mobile device of a person who requests a shared key. The method comprises receiving a first user input; in reaction to the first user input, sending a first digital certificate containing an account ID of a device-side user account for at least one mobile device; receiving a second user input to initiate a sharing procedure of a shared vehicle key for the motor vehicle, wherein the shared vehicle key is derived from a digital vehicle key for the motor vehicle; in reaction to the second user input, sending a prompt message relating to the sharing procedure, wherein the prompt message is signed based on the first certificate; and initiating starting of a drive motor of the motor vehicle based on the shared vehicle key.

A second aspect of the present invention relates to a further method for controlling an access to a motor vehicle. The method can be implemented, for example, on the server side or in a backend for the motor vehicle, a service, or the like. The method comprises receiving a first digital certificate; storing the first certificate in assignment to an account ID of a device-side user account for at least one mobile device; receiving a first prompt message relating to a sharing procedure of a shared vehicle key for the motor vehicle, wherein the shared vehicle key is derived from a digital vehicle key for the motor vehicle; checking a signature of the first prompt message based on the stored first certificate; and, based on the check, selectively initiating the creation of an invitation message relating to a sharing of the shared vehicle key at the mobile device.

Embodiments of the invention enable a check that the shared or derived vehicle key is actually stored as intended on a mobile device which is assigned to an intended user account. Such a verification can take place at the earliest possible time in the key sharing procedure, and therefore optimizes both security interests and a resource consumption in comparison to a verification which only takes place, for example, when an endpoint with the associated data and information is already established in the mobile device, with the corresponding interactions between (relay) servers and mobile device.

A “mobile device” is to be understood herein as a tablet or smartphone, a smartwatch, a smart band, smart ring, etc., but in general any device on which a digital vehicle key, a shared vehicle key, etc. can be stored, and which can be used for an access to a motor vehicle. This could also be a constellation of a mobile device with a smartcard, or any other constellation or any other, also future device which has the required processor capacities, storage capacities, etc.

A user of a mobile device is often provided with a user account by a producer of the mobile device, in which the user is (for example, automatically) logged in upon the use of the mobile device. Such an account is also referred to as a device OEM (“Original Equipment Manufacturer”) user account of the mobile device, however, reference is sometimes made herein for the sake of clarity to a “device-side user account” in short. It is to be noted that such a device-side user account can additionally or alternatively also be provided by a network operator of a communication network via which the mobile device communicates, or by an employer of the user who provides mobile devices to his or her employees.

The user can operate multiple mobile devices (for example, of the same producer) under the same account, thus, for example, a smartphone, a smartwatch, a tablet, etc., or also a plurality of smartphones (for example, of one producer, having the same operating system, etc.), which are available to the employees of a company. In general, data relating to such a user account, thus a user profile, for example, can be kept in an infrastructure or also a “backend” for the mobile device, which is provided or operated, for example, by the producer of the mobile device or the mobile devices.

An account ID (“account identifier”, “account identification number”, etc.) for such a user account can be formed so that this account ID is identical for all mobile devices assigned to the account or is formed in the same way on all devices. For example, the account ID can be determined or calculated based on a username which is assigned to the user account, or it can be an ID permanently assigned upon the creation of the user account, etc. In preferred embodiments, the account ID of a device-side user account for a mobile device is formed in anonymized form, thus so that no inferences about the person of the user, the user profile, other properties of the user account, etc. are possible from the account ID.

A mobile device can have at least one secured environment or a secured element, for example a cryptographic processor. In specific examples, it can be, for example, an HSM (“Hardware Security Module”), TPM (“Trusted Platform Module”), a “Secure Enclave”, a TEE (“Trusted Execution Environment”), and/or a secured element (“Secure Element”), etc. An electronic, cryptographic, or digital vehicle key, a derived vehicle key, etc. can be stored, for example, in such a secured environment.

A digital certificate can in general be part of a PKI (“Public Key Infrastructure”). A certificate can be, for example, an “intermediate certificate” or an endpoint certificate (“end entity certificate”). In some embodiments, an intermediate certificate can be a certificate which is an instance of a CA (“certificate authority”), thus an instance CA certificate. Such a CA can be provided, for example, in a secured environment of a mobile device.

In some embodiments of the first aspect of the invention, the first user input comprises an authorization of the user to read the account ID out of a secured environment of the mobile device. In these embodiments, it is possible to prevent the account ID from being used without knowledge of the user, independently of whether the account ID is to be used during a registration, for verification purposes, etc. Alone or together with the fact that the account ID is formed in anonymized form, interests of data protection can thus be taken into consideration in the best possible manner.

In some embodiments of the second aspect of the invention, the storing of the first certificate and/or the account ID can take place with respect to a service-side or vehicle-side user account, thus, for example, at a service, a producer of the motor vehicle, in a backend for the vehicle, etc. In this way, a permanent or binding assignment (or a “binding”) to the user or the user account in the vehicle-side backend can be established for one mobile device (more precisely its secured environment) or multiple mobile devices, for example for the purposes of verification, checking, enforcement, etc. on the level of the device-side user account.

In some of these embodiments, an account ID having a first certificate stored for it, i.e. stored in assignment, can already exist (for example, from a prior registration of a mobile device assigned to the same user account). In this case, the account ID is not to be stored again, but rather the first certificate is also to be stored in assignment to the already stored account ID. A plurality of first certificates which relate to a plurality of corresponding mobile devices are thus stored in assignment to the account ID.

In some embodiments of the first and/or second aspect of the invention, the first certificate is output by a device-side instance. In specific ones of these embodiments, a CA exists in a secured environment of the mobile device and outputs the first certificate. In some of these embodiments, the first certificate can be at least indirectly cross-signed by a motor vehicle-side instance, thus, for example, by a CA in a backend for the motor vehicle. In this way, a very high level of trust can be established in the form of a “chain of trust”.

The first certificate can adopt different positions in the chain of trust here. In some of these embodiments, the first certificate can be signed based on an instance CA certificate, thus, for example, using a private key component, wherein the corresponding public key component is contained in the certificate. The instance CA certificate can be output by the CA in the secured embodiment.

In some embodiments of the first and/or second aspect of the invention, the account ID can be contained in the first certificate, for example in an expansion. The first certificate containing the account ID with respect to the user account can also be referred to as a “user account certificate”, even if or although it is output by a CA in the mobile device, and even if or although it was output without interaction with a device-side backend. The first certificate can occasionally also be referred to as a user account certificate, although it does not contain the account ID, but nonetheless is used as described herein with reference to the first certificate or the user account certificate.

In specific embodiments of the second aspect of the invention, the account ID can be received separately from the first certificate, thus, for example, from device-side infrastructure. For example, a service or a key management function in the vehicle-side backend can request the account ID directly from a device backend. The device backend will only return the (anonymized) account ID if an authorization of the user is present. Alternatively, the mobile device or a device-side backend can also give the (anonymized) account ID automatically to the vehicle-side backend if a user-side authorization for this purpose is present.

In some embodiments of the second aspect of the invention, the invitation message contains a sharing reference relating to the sharing procedure. The sharing reference can be, for example, a link, pointer, URI (“uniform resource indicator”), or a URL (for example according to the CCC). Such a URL is also occasionally referred to herein as an “invitation URL” or “sharing URL”.

Some embodiments of the second aspect of the invention furthermore comprise storing a second certificate in assignment to the account ID, wherein the first certificate and the second certificate are part of a chain of trust; receiving a second prompt message relating to the sharing procedure, wherein the second prompt message contains a third digital certificate; checking the third certificate in relation to the stored second certificate; and, based on the check, enforcing a sharing of the shared vehicle key with the mobile device.

In some of these embodiments, the second certificate can be an instance CA certificate which is issued by a local CA in the mobile device. The first and the second certificate can thus be stored together with the account ID during a registration, etc., or stored in assignment to an account ID which had already been stored earlier. A plurality of first certificates, for example user account certificates, can thus be or become stored for one account ID, and a corresponding plurality of second certificates, for example instance CA certificates, can be or become stored.

In some embodiments according to the invention, the third certificate is part of a train of trust for an endpoint certificate, which, for example according to the CCC, goes from the mobile device to the vehicle-side backend, service, etc., during the key sharing procedure. The third certificate can be an instance CA certificate which is issued by a local CA of the mobile device. The enforcement (of a binding on the device level) can thus be based, for example, on the comparison of two instance CA certificates. In some embodiments, these and any instance CA certificates are only used for purposes of verification on the device level, thus, for example, for signing another certificate such as the user account certificate, but not for signing any arbitrary other data such as the first prompt message. Rather, the or each user account certificate is used for the purposes of the signature of the first prompt message and the corresponding check of this signature.

In some embodiments according to the invention, for example, an invitation message, push message, etc. having the sharing reference can thus be forwarded within a group of devices of the device-side user account. For example, a signature based on a first user account certificate of this group can exist, and the push message having a URL can be forwarded to another device of this group. The verification of the signature then nonetheless functions, because the corresponding user account certificate is to be stored under the service-side or vehicle-side user account (for the common account ID). Each individual one of the devices has to be subject to the binding assignment, i.e. under or in assignment to the relevant account ID, the respective user account certificate and the device certificate (for example, instance CA certificate) has to be stored or present for each of these devices.

Stated more generally, many devices (for a device-side user account with the same account ID) can be stored under a user account of a service or key management function, specifically in the sense that a device certificate and a user account certificate exist for each device. The latter certificates can contain the same account ID, for example as an expansion.

If the binding assignment is established in this manner, an initial prompt message relating to key sharing can already be signed, for example, by an authorized device of a relevant user account. A check of this signature can already take place (and the further key sharing can possibly be terminated) if no further interactions have yet taken place between this or another device and the vehicle-side or service-side backend (and the vehicle). A consumption of corresponding resources, including communicative resources between the mentioned entities, can thus be minimized.

In some embodiments of the second aspect of the invention, the “enforcement” (“binding”) accordingly in particular comprises preventing the key to be shared from being stored on a mobile device which is assigned to a user account other than the one intended (i.e. an enforcement on the level of the user account, wherein the respective user can himself or herself decide on which of his or her devices the shared vehicle key is to be stored), and/or preventing the key to be shared from being stored on a mobile device other than the one intended (i.e. an enforcement on the device level).

In still other words, embodiments of the invention provide a framework using which, for example, a binding assignment on the device level can be enforced on the service side (by means of a device certificate or instance CA certificate), but in addition an early verification (of signed prompt messages or also corresponding confirmations) can be carried out, in order to thus enforce a binding assignment on the level of the device-side user account (by means of the anonymized account ID).

A further aspect of the present invention relates to a mobile device which is designed to control an access to a motor vehicle according to a method described herein. The mobile device can in particular comprise a secured environment (for example, based on a corresponding cryptoprocessor, etc.). The secured environment can be designed to store a digital vehicle key, for example a shared vehicle key. The secured environment can be designed to calculate an account ID of a device-side user account for the mobile device.

In some embodiments, a certification body, instance, certification instance, CA, etc. for outputting certificates can be present in the secured environment. The secured environment can be designed to store a plurality of digital certificates, for example instance CA certificates and/or user account certificates.

Software, an application, etc. can be installed on the mobile device, which permits for the user the device-side control of a key sharing procedure, a one-time or permanent grant of an authorization to read a user account certificate relating to an account ID, sending the user account certificate, etc.

Still a further aspect of the present invention relates to a server, for example in a service-side and/or vehicle-side backend, wherein the server is designed to control an access to a motor vehicle according to one of the methods described herein. The server can also be multiple servers, a server landscape, etc. The server or servers can be operated, for example, by a service provider and/or a producer of the vehicle. Software can be installed on the server, which permits, for example, a provider to have service-side or administrative control, control of a key management function, in particular of a key sharing procedure, etc.

Still a further aspect of the present invention relates to a system for controlling an access to a motor vehicle. The system comprises the motor vehicle, a mobile device described herein, and a backend server described herein. The vehicle can be designed to store a digital vehicle key, also a derived vehicle key. The system can also comprise a plurality of mobile devices, for example of a producer, a customer, a company or service provider, etc. The system can also comprise a plurality of vehicles, for example of a producer, a company or service provider, etc.

The invention will now be described in more detail with reference to the appended drawings, in which:

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 illustrates a system;

FIG. 2A illustrates a flow chart of a first method;

FIG. 2B illustrates a flow chart of a second method;

FIG. 3A illustrates a flow chart of a third method; and

FIGS. 3B and 3C illustrate a flow chart of a fourth method.

### DETAILED DESCRIPTION OF THE DRAWINGS

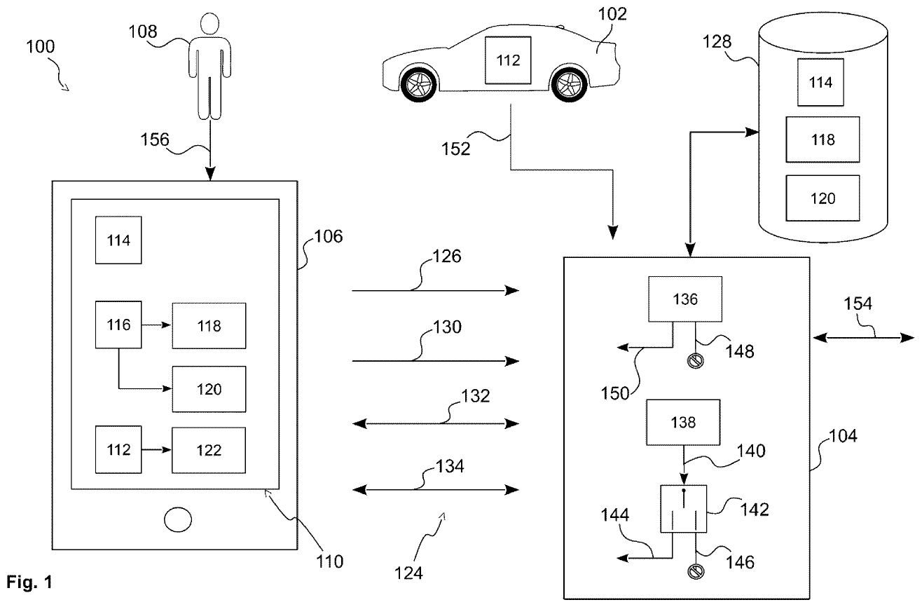

FIG. 1 shows in schematic form a system 100 having a motor vehicle 102, a server 104 in a backend for the vehicle 102, and a mobile device 106 of a user 108. The reference sign “104” is used hereinafter both to designate in general a or the backend 104 (in particular for the vehicle 102) and to specifically designate the server 104, wherein the server 104 can also be a plurality of servers connected to one another, for example a server of a service provider such as an administrative owner or operator of the vehicle 102 (wherein the vehicle 102 can belong to a vehicle fleet, for example), a server of a producer of the vehicle 102 (for example, for a service of a key management function, a technical key management function), a server of a producer of the mobile device 106, etc.

The mobile device 106 has at least one secured environment 110, which can comprise, for example, a secured element (“secure element”), a “secure enclave”, a TEE etc. The secured environment 110 can be operated, for example, by a cryptographic processor. A cryptographic or digital vehicle key can be or become stored, inter alia, in the secured environment 110, in particular a shared, allocated, or derived vehicle key 112 (“friend key” according to the CCC) for an access to the vehicle 102.

An account ID 114 for a device-side user account of the user 108 can also be calculated and/or determined and be or become temporarily or permanently stored in the secured environment 110. The user account can be based, for example, on a device-side user profile, which is kept on a server (not shown), which is operated in a backend for the mobile device 106, for example by a device producer of the mobile device 106. The user 108 can be registered under the same user account in succession or simultaneously on multiple mobile devices of the same producer.

The account ID 114 can be based on a calculation which leads to an identical result on each of these mobile devices (but to a different result for another user account). Additionally or alternatively, the account ID 114 can also be assigned once (and uniquely) for the or each user profile and can be retrievable in a secure manner for all mobile devices of the user 108. The account ID 114 is preferably to be anonymized.

In the secured environment 110, for example an intermediary certification instance or CA 116 is provided, which issues digital certificates. For example, a user account certificate 118 is indicated in FIG. 1, in respect of which it is assumed that it contains the account ID 114, for example in an expansion, specification of a key usage, etc. Furthermore, an instance CA certificate 120 is indicated, in respect of which it is assumed that it does not contain the account ID 114. The two certificates 118 and 120 can be part of a chain of trust, for example, the user account certificate 118 can reference the instance CA certificate 120 or a private key component (not indicated in FIG. 1) assigned to the instance CA certificate 120 can be used for a signature of the user account certificate 118.

Furthermore, an endpoint certificate 122 is indicated in the secured environment 110, which can be generated in the course of a key sharing procedure. The endpoint certificate 122 contains a public key component of the derived vehicle key 112 (a device-side private key component is likewise stored in the secured environment 110, but is not shown for the sake of clarity).

With authorization of the user 108, the user account certificate 118 having account ID 114 is to be used for administrative procedures of the key sharing which are trustworthy such that it can be ensured that the key 112 shared to the authorized user 108 is only activated for the vehicle 102 when the key 112 is actually stored on a mobile device that is assigned to the user account of the user 108 (and not on a mobile device of another user or user account). The security check is not to exclude that multiple devices are assigned to the user account of the user 108, but all of these devices have to be known under the account ID 114, i.e. assigned in a binding manner to the corresponding user account.

A secured key sharing procedure 124 according to the invention is generally indicated in FIG. 1. A registration procedure 126 can precede this, in which a binding assignment, under the account ID 114 (relating to the device-side account of the user 108 with respect to the mobile device 106), the mobile device 106 (and possibly further mobile devices) in a user profile 128 of the user 108 in the service-side and/or vehicle-side backend 104 is established for the vehicle 102. The binding assignment is established by means of the user account certificate 118 and/or the instance CA certificate 120 for the mobile device 106 (and possibly corresponding further certificates for further mobile devices). The user profile 128 can relate to a user account of the user 108 with a service provider with respect to the vehicle 102, and/or can relate to a user account of the user 108 with a producer of the vehicle 102.

In a procedure such as a registration 126, in particular the user account certificate 118 can be used to transfer the account ID 114 to the backend 104 in a particularly trustworthy manner. For example, the user account certificate 108 can reference the instance CA certificate 120, and this can be “cross-signed” by a CA (not shown) in the backend 104, or the instance CA certificate 120 references a further (not shown) device-side CA certificate (for example, of a producer of the device 106), which is cross-signed by a CA in the service-side or vehicle-side backend 104.

As stated, multiple user account certificates, like the certificate 118, and multiple instance CA certificates, like the instance CA certificate 120, can be stored in assignment to the account ID 114, for example in the profile 128. More precisely, for example, for each further device, a user account certificate and an instance CA certificate for the account ID 114 are stored, i.e. the account ID 114 itself does have to be known in the user account certificate here, but does not have to be removed and does not have to be stored again.

The binding (for the purposes of enforcement) assignment of account ID 114 and one or more user account certificates and possibly one or more instance CA certificates established in this way can be stored secured in a special manner in the backend 104. For example, the user profile 128 as a whole can be stored in a hardened zone, secured environment, a secured element of a very high security level, etc.

FIG. 1 schematically indicates that the key sharing procedure 124 is divided into an initiation 130, a first part 132, and a second part 134. During the initiation 130, a verification on the user level or user account level takes place in a first verification module 136 in the backend 104, which is only schematically indicated. Between the parts 132, 134 of the key sharing, a verification on the device level takes place in a second verification module 138 in the backend 104. In principle, forwarding of an invitation or sharing URL between devices can therefore take place in the first part 132 of the key sharing, but only between devices of the same user account, otherwise the verification will fail in the second module 138.

More precisely, the modules 136, 138 are to be understood functionally and can each comprise service-side procedures and/or procedures of a key management function. Thus, for example, based on a verification result 140 provided by the module 138, a corresponding discrimination can be enforced by an enforcement module 142, in which according to branch 144, the further key sharing 134 takes place, or according to branch 146, the further key sharing 134 does not take place, but rather the key sharing 124 is terminated.

It can be ensured using this mechanism that the key 112 only becomes active when it is stored on the mobile device 106 of the user 108 intended for this purpose (for example, on one of multiple devices of the user which are assigned in a binding manner to the user account via registration or the like), otherwise the key 112 will not be activated and allows no or only restricted access to the vehicle 102.

At the beginning of the key sharing 124, 130 for the mobile device 106, a corresponding prompt message is transmitted to the backend 104. The prompt message is signed using a key assigned to the user account certificate 118 (more precisely, using the corresponding private key component which is kept in the secured environment 110). The signature can be verified in the backend 104, 136 based on the user account certificate 118, because this is present in the user profile 128. The prompt message could also be sent using another device, however, which is assigned to the device-side user account of the user 108 (having identical account ID), and which is likewise registered as such in the binding assignment in the user profile 128 (with a corresponding user account certificate).

If the verification in the module 136 fails (branch 148), the further key sharing procedure can be terminated in an early stage. If the verification runs positively (branch 150), in the first part 132 of the key sharing according to the CCC, the endpoint certificate 122 of the mobile device 106 is transmitted to the backend 104. The certificate 122 can be part of a chain of trust, which also comprises the certificate 120 (i.e. the instance CA certificate 120 is likewise transmitted). Based thereon, the verification module 138 can perform a check of whether the device from which the sharing URL was called is subject to the binding assignment according to the user profile 128.

Upon successful verification in the module 138 (branch 144), the further key sharing procedure 134 can run, which finally has the result that the derived key 112 is stored in the vehicle 102 and activated; this makes the vehicle 102 known to the backend 104 in a procedure 152.

As stated, the account ID 114 can reach the backend 104 by means of the user account certificate 118, for example during the registration 126. In some exemplary embodiments, sending the account ID 114 from the mobile device 106 is to be minimized or avoided entirely for security reasons. The user account certificate is then transmitted without account ID 114. For the purposes of establishing a binding assignment in the user profile 128, the account ID 114 then has to be determined in another way. The account ID 114 is preferably determined in a secure manner in a procedure 154. This can take place, for example, based on information which is determined from the certificate 118 and possibly the certificate 120.

In some exemplary embodiments, the account ID 114 can be kept, for example, in an infrastructure of the device producer for the mobile device 106 and can pass from there (i.e. not from the secured element 110 of the mobile device 106) to the backend 104. The procedure 154 can be initiated, for example, during the registration 126 from the mobile device 106 or from the backend 104. An initiation from the mobile device 106 has the advantage that each transmission of the account ID 114 can be preceded in a simple manner by an authorization 156 of the user. This authorization 156 can precede each reading or use of the account ID 114, also the reading or sending of the user account certificate 118 from the secured environment 110.

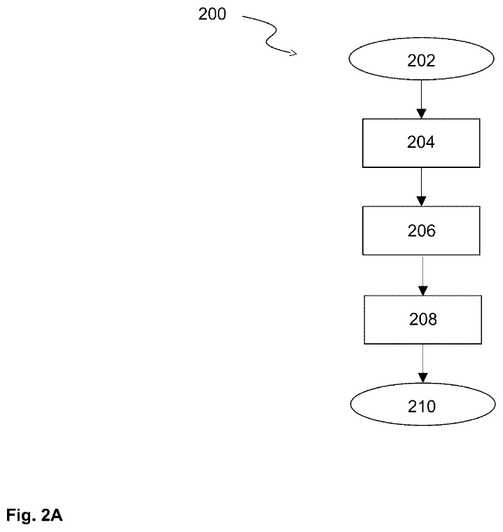

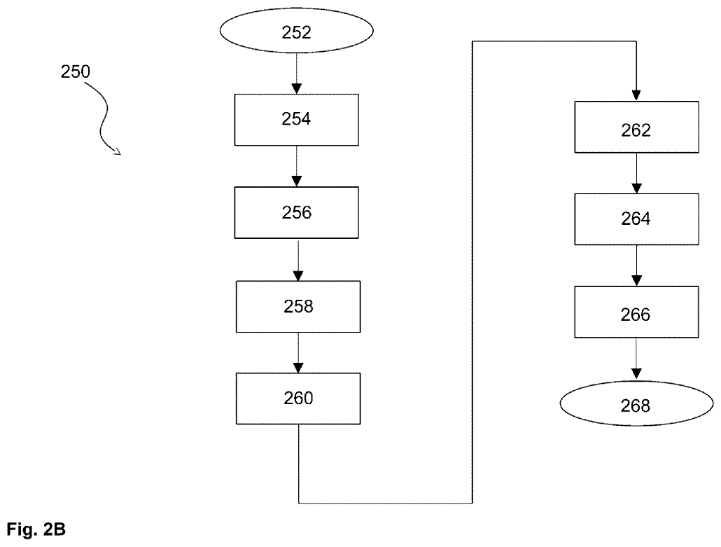

An exemplary embodiment of a key sharing method in the scenario 100 from FIG. 1 will be described in more detail hereinafter with reference to the sequences schematically shown in FIGS. 2A and 2B. In this case, FIG. 2A shows a sequence of a method 200 for controlling an access to the motor vehicle 102 in the mobile device 106. FIG. 2B shows a sequence of a corresponding method 250 in the backend 104.

It is to be noted that the method 200 from FIG. 2A can run in the mobile device 106, but also entirely or partially in a backend for the mobile device 106; however, this will not be described in more detail hereinafter for reasons of clarity. Furthermore, it is to be noted that any communication 124, 126 described hereinafter between mobile device 106 and service-side or vehicle-side backend 104 can be based for example on one connection or multiple connections based on mobile wireless and/or on wireless connections having short range, in which, for example, the vehicle 102 can be used as a relay station for forwarding the communication between mobile device 106 and the or a backend server 104. This will likewise not be described in more detail in the further description for reasons of clarity.

A sequence can begin with the prior registration 126 of the user 108 having the mobile device 106 with a service provider. In detail, for this purpose in a step 202 in the method 200 in FIG. 2A, a user input is received, which triggers the registration procedure 126, for example in an app (not shown in FIG. 1) of the service provider on the mobile device 106. The user input can additionally comprise an authorization 156 of the user to use the account ID 114, for example to create and/or send the user account certificate 118 containing the account ID 114.

In reaction to the user input, in step 204, the digital certificate 118 containing the account ID 114 is sent to the backend 104. Optionally, the instance CA certificate 120 is likewise sent to the backend 104. For example, the user account certificate 118 and the instance CA certificate 120 can be part of a chain of trust; in one exemplary embodiment, the instance CA certificate 120 relates to a cryptographic key, using which the user account certificate 118 is signed.

The account ID 114 can already be present, or can be generated, retrieved, or provided in another manner in reaction to the user input in step 202. Each of the certificates 118 and 120 can likewise already be present, or can be generated or issued in reaction to the user input in step 202. The generation can comprise, for example, an interaction with a backend for the mobile device 106, for example for signing the certificate 118. If the account ID 114 is to be sent as little as possible, the generation, for example, of the user account certificate 118 can also run without interaction with a backend.

A corresponding sequence of the method 250 in FIG. 2B with respect to the registration 126 begins in a step 252 with receiving the certificate 118 in a corresponding prompt message (registration message) at the backend server 104, for example with a service provider. The account ID 114 can be contained in the user account certificate 118 or can be received from a device-side backend, as was described above.

In reaction to receiving the certificate 118, in a step 254, the certificate 118 is verified, for example against a cross-signed certificate of the device producer for the mobile device 106 and in the event of positive verification is stored in assignment to the account ID 114 for the user profile 128. More precisely, the account ID 114 can be stored when a device-related certificate is not yet present in assignment to this account ID, i.e. the mobile device 106 is the first device for which a binding assignment is to be established. Upon the registration of further devices, only the corresponding certificates are added.

The key sharing 124 begins in method 200 in FIG. 2 with a step 206 in which a corresponding user input is received, using which the key sharing procedure 130 is initiated. In reaction thereto, in a step 208, a corresponding prompt message is sent to the service-side or vehicle-side backend 104. The prompt message is signed based on the user account certificate 118, i.e. the user account certificate 118 relates to a cryptographic key, and the prompt message is signed using this cryptographic key, more precisely its private key component.

Corresponding thereto, in method 250 in FIG. 2B, in a step 256, the signed prompt message is received. In reaction thereto, in a step 258, the prompt message is verified in the module 136, specifically using the public key component of the above-mentioned cryptographic key, wherein the public key component is contained in the user account certificate 118. In the event of a negative result 148 of the check, i.e. if the signature cannot be verified, key sharing does not take place, i.e. the procedures 132 and 134 are not carried out. More precisely, the prompt message received from the mobile device 106 is not processed further, since this message does not originate from a device which is assigned to the user account of the user 108.

In the case of a positive result 150 of the check, in a step 260, the performance of the first part 132 of the key sharing procedure 124 is initiated, which can include, inter alia, that a sharing URL is created and sent to the mobile device 106 via push message. It can also be established that at a later time in the key sharing procedure, a check and possibly enforcement of the binding assignment is to take place (then in particular on the device level).

In the further course of the key sharing 132, the created sharing URL can be called on the mobile device 106. Among other things, this has the result that in the secured environment 110, the endpoint certificate 122 is created based on the shared key 112. The endpoint certificate 122 can be signed by the CA 116. The instance CA certificate 120 can be used as part of the chain of trust for the certificate 122.

In a step 262 (method 250 in FIG. 2B), a further prompt message containing the endpoint certificate 122 and its chain of trust reaches the backend 104. After the check is activated on the device level, in a step 264, it is checked in the verification module 138 on the device level whether the binding assignment is maintained as stored in the user profile 128. More precisely, the instance CA certificate 120 also delivered is verified, i.e. it is checked against the instance CA certificate stored in the user profile 128.

Depending on the result 140 of the verification in step 264, in step 266, an enforcement of the binding assignment takes place in the module 142, i.e. a selective activation of the derived vehicle key 112. If it proves in this case, for example, that the instance CA certificate stored in the user profile 128 does not correspond with a certificate contained in the chain of trust for the endpoint certificate 118, the sharing URL would not be called on a mobile device which is assigned to the user account of the user 108, for example because the URL was forwarded to a device of another user and called from there. In this case 146, an indication can be given to a technical key management function that the key sharing procedure 124 is to be terminated. More precisely, the further key sharing procedure 134 does not take place, data already created in the prior key sharing procedure 132 with respect to the derived key 112 are deleted, etc.

However, if the device certificates correspond 144, the technical key management function in the backend 104 can trigger the further key sharing procedure 134 in a step 268, i.e. the key sharing 124 can be finalized in that, inter alia, the endpoint is authorized in the mobile device 106. Accordingly, in a step 210 in the method 200 in FIG. 2A, starting of a drive motor of the motor vehicle 12 is initiated based on the activated shared vehicle key 112.

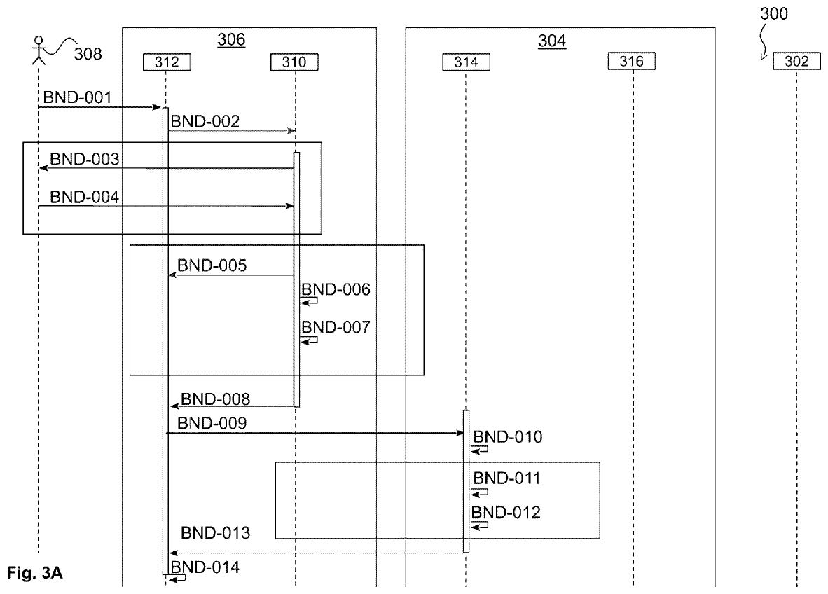

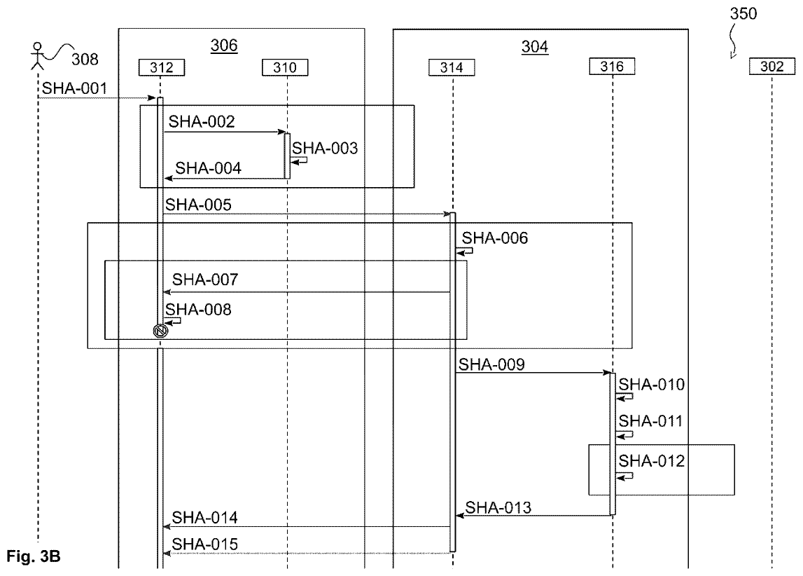

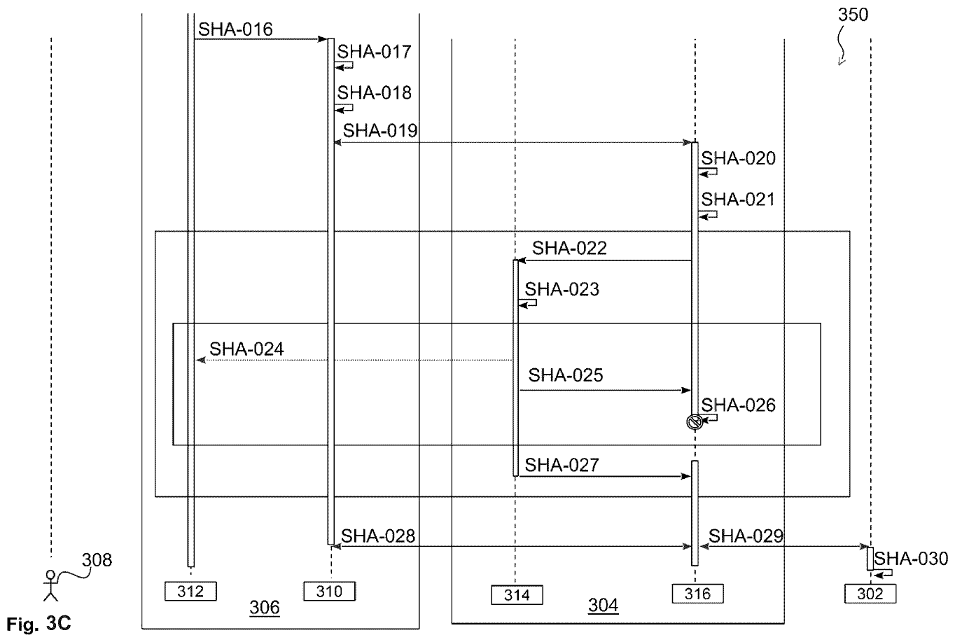

FIGS. 3A, 3B, and 3C illustrate, in the form of schematic sequence diagrams, further exemplary embodiments of method 300, 350 for controlling an access to a motor vehicle 302, wherein a backend 304 for the motor vehicle 302 and a mobile device 306 of a user 308 cooperate. A shared key for the vehicle 302 is to be stored on the mobile device 306.

A (for example, operating-system-specific) secured element 310 is present in the mobile device 306. A service app 312 is involved in the control of the components of the methods 300, 350 which run on the mobile device 306. The backend 304 comprises a server 314 of a service provider, wherein the service can relate, for example, to car sharing, automobile rental, fleet management, etc. The backend 304 furthermore comprises a server 316 for a key management function, which can be operated, for example, by a producer of the vehicle 302. The service app 312 can be provided by the service provider and operator of the server 314 and/or by the operator of the key management function 316.

The user 308, who can be, for example, a customer or an employee of the service provider 314, wishes at a later point in time (method 350 in FIGS. 3B and 3C collectively) to apply for the “sharing” of a vehicle key from the service provider 314. A registration process (method 300 in FIG. 3A) of the user 308 for the service of the service provider 314 takes place beforehand. The user 308 uses the mobile device 306 for the registration. If the user 308 is an “authorized” user in the methods described herein (for example, because he or she is registered), reference is sometimes made in short to his or her mobile device 306 which is “authorized” or “intended” for the key sharing.

For the method 300, it is presumed for the sake of clarity that the user 308 already has a user account with the service provider 314. The service app 312 is logged into the user account. However, there is not yet “binding” there, or a fixed binding assignment (usable for service-side or vehicle-side verification purposes) of user 308 (or a device account assigned thereto), mobile device 306 (and possibly further devices of the user 308), app 312, or secured environment 310.

According to the method 300 described here, the user 308 triggers the method 300 in a step BND-001 in the service app 312 (the method could also be started automatically, for example upon installation of the service app 312 on the mobile device 306). In a step BND-002, the service app 312 sends a prompt message to the secured element 310 relating to providing a user account certificate with anonymized account ID. In an optional step BND-003, the secured element 310 outputs a prompt relating to an authorization of the user on a user interface of the mobile device 306. In a step BND-004, the authorization obtained from the user 308 arrives at the secured element 310.

If a certificate and an account ID are not yet present, in an optional step BND-005, a confirmation is returned from the secured element 310 to the service app 312 that a procedure to output a user account certificate is started. In a step BND-006, an anonymized account ID is calculated in the secured element 310. Alternatively, it is also conceivable that the account ID is acquired from an external source, for example requested from a device-side backend (or obtained automatically therefrom). In a step BND-007, a user account certificate containing the anonymized account ID is output by a CA in the secured element 310. This can include that the user account certificate is signed by a device certificate (more precisely, the device certificate relates to a cryptographic key and the user account certificate is signed by this key). The device certificate can be an instance certificate relating to the secured element, more precisely, an instance CA certificate relating to the mentioned CA.

In a step BND-008, the user account certificate containing the anonymized account ID is returned to the service app 312. In a step BND-009, the service app 312 sends a prompt message relating to a binding assignment of the device 306 to the service provider 314, wherein the prompt message contains the user account certificate having the anonymized account ID, and a chain of trust for the user account certificate containing (at least) the instance CA certificate. In a step BND-010, the service 314 verifies the user account certificate against the instance CA certificate also delivered and the latter against a cross-signed CA certificate of the device producer of the mobile device 306.

In a step BND-011, the service 314 takes the anonymized account ID from the instance CA certificate. The account ID can be used as a clamp or as a structuring element for a binding assignment of device 306 to the user 308, insofar as and if the account ID is formed on all devices of the user 308 in the same manner and/or is stored or accessible otherwise in a secured environment of the respective device. The account ID can have a security level of EAL4+ (“Evaluation Assurance Level 4+”), for example, relating to the secured element 310.

In a step BND-012, the service 314 stores the user account certificate, the instance CA certificate, and the anonymized account ID in assignment to a user account of the user 308 relating to the service 314 and in this way establishes the binding assignment (if at least one device of the user 308 is already stored under the account ID, the account ID does not have to be stored once again, but rather only the additional certificates are stored).

In a step BND-013, the service 314 returns an indication relating to the completed binding assignment to the service app 312 in the mobile device 306. In a step BND-014, the service app 312 updates a status relating to the binding assignment.

The method 350 illustrated in FIG. 3B relates to the actual key sharing based on the binding assignment, which was established in method 300. The binding assignment established in method 300 is used for an early verification on the level of the user account and, after the establishment of an endpoint for the shared vehicle key, for verification and enforcement of the binding assignment on the device level.

In a step SHA-001, the user 308 initiates the key sharing procedure via the service app 312. In a step SHA-002, the service app 312 sends a prompt to sign a prompt message relating to key sharing to the secured element 310. In a step SHA-003, the prompt message is signed; more precisely, the user account certificate stored in the secured element 310 relates to a cryptographic key using which the prompt message is signed. In a step SHA-004, the secured element 310 returns the signed data.

In a step SHA-005, the service app 312 sends the signed prompt message relating to key sharing for a vehicle to the service 314. In a step SHA-006, the service 314 verifies the signed prompt message; more precisely, the service 314 verifies the signature of the prompt message using a public key component contained in the relevant user account certificate, which was stored during the registration in the user profile for the relevant account ID (the user account certificate can contain the account ID; other possibilities for determining the account ID during the initiation 130 of the key sharing 124 were described above).

If the signature is not recognized as valid, the service 314 returns, in a step SHA-007, as the result to the service app 312 that the signature cannot be verified. In a step SHA-008, the service app 312 outputs a corresponding error message on a user interface of the mobile device 306. Further key sharing 124, 132, 134 does not take place, i.e. the prompt message sent in step SHA-005 from the mobile device 306 relating to key sharing is no longer further processed.

In contrast, if the signature is recognized as valid in step SHA-006, the service 314 sends, in a step SHA-009, a prompt message to create a sharing URL for a vehicle including later enforcement of a binding assignment to the key management function 316. That an enforcement is to take place can be configured or is defined, for example, on the service level, for specific user groups, etc., because up to this point only a verification on the level of the user account was carried out.

In a step SHA-010, the key management function 316 initiates the key sharing procedure. In a step SHA-011, the key management function 316 generates a sharing URL. In a step SHA-012, it is defined that in the further key sharing, a check of the requirements for an enforcement of the binding assignment is to take place. In a step SHA-013, the key management function 316 returns the generated sharing URL to the service 314. In a step SHA-014, the service 314 returns an indication relating to the successful triggering of the key sharing procedure 132 to the service app 312. In a step SHA-015, the service 314 sends a push message relating to the sharing URL to the service app 312.

In a step SHA-016, the service app 312 arranges calling of the sharing URL. The secured element 310 thereupon initiates the key sharing in a step SHA-017. In a step SHA-018, the secured element 310 creates an endpoint and outputs an endpoint certificate for the shared vehicle key. It is to be noted that the private key component of a digital vehicle key remains in the secured element 310.

In a step SHA-019, a sequence flow for sharing a derived key (for example, “friend key” according to the CCC) takes place, inter alia, in interaction of secured element 310 and key management function 316. In this case, inter alia, the endpoint certificate output in step SHA-018 in the secured element 310 including chain of trust arrives at the key management function 316. In a step SHA-020, the key management function 316 verifies the chain of trust of the device certificate. In a step SHA-021, the key management function 316 checks whether requirements relating to the enforcement of a binding assignment for the key sharing procedure are met. Since such requirements are met, the binding assignment is verified.

For this purpose, the key management function outputs, in a step SHA-022, a prompt message containing the instance CA certificate from the chain of trust of the received endpoint certificate to the service 314. In a step SHA-023, this service checks the binding assignment, specifically with respect to the instance CA certificate. More precisely, the enforcement only takes place here on the device level (i.e. the CA instance on the intended device): each device that is subject to the account ID of the device-side user account of the user also has to be contained in the binding assignment in a verifiable manner as such (using the corresponding instance CA certificate stored on the service side since the registration).

If the verification fails, in an optional or selective step SHA-024, an indication relating to an invalid target of the key sharing is given to the service app or device app 312, i.e. it is communicated that the sharing URL was called on an incorrect user device. In a further optional step SHA-025, the service 314 returns an indication relating to the invalid target of the sharing to the key management function 316. The key management function 316 thereupon terminates, in a step SHA-026, the key sharing procedure 132, i.e. the processing of the prompt of the service app 312 for sharing a derived key is no longer continued. In this way, it is enforced that a shared key can only be activated when it is stored on an authorized mobile device 306 (more precisely, in the secured environment 310).

If the verification in step SHA-023 runs positively or the check is successful, the service 314 gives, in a step SHA-027, corresponding feedback to the key management function 316. Thereupon, in a sequence flow SHA-028 according to the CCC between secured element 310 and key management function 316, and in a sequence flow SHA-029 according to the CCC between key management function 316 and vehicle 302, the sharing procedure 134 is carried out or the key sharing 124 is finalized. Finally, in a step SHA-030, the shared key is persisted in the vehicle 302.

Exemplary embodiments of the invention can ensure or enforce that a vehicle key derived or shared from a digital vehicle key is activated or can be activated only if it is stored on an authorized mobile device, i.e. a mobile device of the authorized user which is assigned to a device-side user account of the user, as is known on the part of a service provider by a registration or the like.

A corresponding verification can take place, for example, on the level of the user account at the earliest possible time in the key sharing procedure, namely when a corresponding request for a key or prompt for key sharing arrives on the service side from a mobile device. The prompt can be signed using a user account certificate (relating to an account ID), and this signature can be checked accordingly. In this way, both security interests can be optimized and also a resource consumption with respect to service-side processing capacities, communicative capacities, etc. can be minimized, specifically in comparison to a verification which first takes place, for example, when an endpoint with the associated data and information is already established in the mobile device, with the corresponding interactions between (relay) servers and mobile device.

At the same time, the check on the level of the user account enables forwarding of an invitation message or sharing URL to still be possible on the device side, but only between devices which are assigned to the relevant user account, wherein the assignment is binding, i.e. was made known with the corresponding registration on the service side or vehicle side (for example, relating to a key management function). This enables applications or business models in which a user account is assigned, for example, to a company, a group of employees having respective devices, etc.

Exemplary embodiments of the invention can prevent a misuse in which a URL for key sharing is forwarded, for example, from an intended or authorized mobile device in an unauthorized manner to another device (for example, of another user). In this way, the level of trust in server-based or administrative methods for digital key sharing is in turn increased, which are becoming more and more important, for example, for business models such as vehicle rental, car sharing, fleet management, etc. with the increasing propagation of digital vehicle keys. Exemplary embodiments of the invention generally increase the practicability and security of digital vehicle keys.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LIST OF REFERENCE SIGNS

100 system
102 motor vehicle
104 backend
106 mobile device
108 user
110 secured environment
112 shared vehicle key
114 account ID
116 CA
118 user account certificate with account ID
120 CA certificate without account ID
122 endpoint certificate
124 secured key sharing procedure
126 registration, “binding”, establishing a binding assignment
128 user profile in the backend for the vehicle 102
130 key sharing procedure, initiation
132 key sharing procedure, first part
134 key sharing procedure, second part
136 first verification module
138 second verification module
140 result of the second verification
142 enforcement module
144, 146 outputs of the module 142
148, 150 outputs of the module 136
152 key activation
154 determining the account ID
156 user authorization
200 method in the mobile device 106
202 user input
204 sending the certificate 118 and optionally the certificate 120
206 initiating the key sharing
208 sending a prompt message
210 starting the motor by means of the vehicle key 112
250 method in the backend 104
252 receiving the certificate 118 and optionally the certificate 120
254 storing the certificate 118 (120), and possibly the account ID 114
256 receiving a signed prompt message
258 checking the signature
260 initiating the further key sharing
262 receiving the certificate 122 with chain of trust
264 checking certificates
266 enforcing the sharing to an authorized mobile device
268 performing the further key sharing 134
300, 350 method
302 motor vehicle
304 backend
306 mobile device
308 user
310 secured environment
312 service app
314 service provider/server
316 key management function
BND-001-BND-014 establishing a binding assignment
SHA-001-SHA-008 initiating key sharing
SHA-009-SHA-019 key sharing, first part
SHA-020-SHA-027 enforcing the binding assignment
SHA-028-SHA-030 key sharing, second part

What is claimed is:

1. A method for controlling an access to a motor vehicle, comprising:
receiving a first user input;
in reaction to the first user input, sending a first digital certificate comprising an account ID of a device-side user account for at least one mobile device;
receiving a second user input to initiate a sharing procedure of a shared vehicle key for the motor vehicle, wherein the shared vehicle key is derived from a digital vehicle key for the motor vehicle;
in reaction to the second user input, sending a prompt message relating to the sharing procedure, wherein the prompt message is signed based on the first certificate; and
initiating starting of a drive motor of the motor vehicle based on the shared vehicle key.

2. The method according to claim 1, wherein the first user input comprises an authorization of the user to use the account ID.

3. The method according to claim 1, wherein the first certificate is output by a device-side CA instance.

4. The method according to claim 3, wherein the first certificate is at least indirectly cross-signed by a motor vehicle-side instance.

5. The method according to claim 1, wherein the first certificate comprises the account ID.

6. A method for controlling an access to a motor vehicle, comprising:
receiving a first digital certificate;
storing the first certificate in assignment to an account ID of a device-side user account for at least one mobile device;
receiving a first prompt message relating to a sharing procedure of a shared vehicle key for the motor vehicle, wherein the shared vehicle key is derived from a digital vehicle key for the motor vehicle;
checking a signature of the first prompt message based on the stored first certificate; and
based on the check, selectively initiating the creation of an invitation message relating to sharing the shared vehicle key to the mobile device.

7. The method according to claim 6, wherein the first certificate is output by a device-side CA instance.

8. The method according to claim 7, wherein the first certificate is at least indirectly cross-signed by a motor vehicle-side instance.

9. The method according to claim 6, wherein the first certificate comprises the account ID.

10. The method according to claim 6, wherein the account ID is received separately from the first certificate.

11. The method according to claim 6, wherein the invitation message comprises a sharing reference relating to the sharing procedure.

12. The method according to claim 6, further comprising:
storing a second certificate in assignment to the account ID, wherein the first certificate and the second certificate are part of a chain of trust;
receiving a second prompt message relating to the sharing procedure, wherein the second prompt message comprises a third digital certificate;
checking the third certificate against the stored second certificate; and
based on the check, enforcing sharing the shared vehicle key to the mobile device.

13. The method according to claim 12, wherein the third certificate is part of a chain of trust for an endpoint certificate.

14. The method according to claim 12, wherein at least one of the second or the third certificate is an instance CA certificate.

15. A mobile device configured to control an access to a motor vehicle according to a method according to claim 1.

16. The mobile device according to claim 15, comprising:
a secured environment configured to:
calculate an account ID of a device-side user account for the mobile device; and
store a digital vehicle key and at least one digital certificate.

17. A backend server configured to control access to a motor vehicle according to a method according to claim 6.

18. A system for controlling an access to a motor vehicle, comprising:
the motor vehicle configured to store a digital vehicle key;
at least one mobile device configured to control an access to a motor vehicle according to a method, comprising:
receiving a first user input;
in reaction to the first user input, sending a first digital certificate comprising an account ID of a device-side user account for at least one mobile device;
receiving a second user input to initiate a sharing procedure of a shared vehicle key for the motor vehicle, wherein the shared vehicle key is derived from a digital vehicle key for the motor vehicle;
in reaction to the second user input, sending a prompt message relating to the sharing procedure, wherein the prompt message is signed based on the first certificate; and
initiating starting of a drive motor of the motor vehicle based on the shared vehicle key; and
a backend server configured to control access to a motor vehicle according to a method, comprising:
receiving a first digital certificate;
storing the first certificate in assignment to an account ID of a device-side user account for at least one mobile device;
receiving a first prompt message relating to a sharing procedure of a shared vehicle key for the motor vehicle, wherein the shared vehicle key is derived from a digital vehicle key for the motor vehicle;
checking a signature of the first prompt message based on the stored first certificate; and
based on the check, selectively initiating the creation of an invitation message relating to sharing the shared vehicle key to the mobile device.
